(19) United States
(12) Patent Application Publication
(10) Pub. No.: US 2006/0224879 A1
(43) Pub. Date: Oct. 5, 2006

(54) METHOD FOR STARTING AN OPERATING SYSTEM RAPIDLY BY PRESSING A HOTKEY

(76) Inventors: Chang-Wen Fu, Shenzhen (CN); Dai-Hua Sun, Shenzhen (CN); Zhi-Jun Xiang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,153

(22) Filed: Mar. 8, 2006

(30) Foreign Application Priority Data
Mar. 31, 2005 (CN) 200510033944.X

(51) Int. Cl. G06F 9/00

(52) U.S. Cl. 713/2

(57) ABSTRACT

A method for starting an operating system rapidly by a hotkey includes the steps of: setting a hotkey for each operating system; executing a BIOS power on self test program; determining whether any hotkey has been pressed during execution of the power on self test program; activating a disk partition section which stores an operating system corresponding to a hotkey if the hotkey has been pressed; loading a master boot record; starting the operating system stored in the activated disk partition section.

### FIELD OF THE INVENTION

The present invention relates to a method for starting an operating system rapidly by pressing a hotkey.

### DESCRIPTION OF RELATED ART

When an operating system of a computer is destroyed, or when a user needs to switch the current operating system to another operating system, a program installed in the computer may be executed to modify the MBR (Master Boot Record) and prompt information in order to indicate the user. After the user conducts a series of actions on the computer according to the prompt information, the backup of the destroyed operating system or another operating system is started, wherein the actions include restarting the computer, choosing one of the operating systems to start etc. Besides, the user also may need to recover the destroyed operating system via an exterior device or load another operating system.

However, it is inconvenient for the user to switch the current operating system to another operating system by the program to modify the MBR or by the exterior device to load the operating system.

What is needed, therefore, is a method which can start an operating system rapidly by a hotkey preestablished by the user.

### SUMMARY OF INVENTION

A method for starting an operating system rapidly by a hotkey in accordance with another preferred embodiment includes the steps of: setting a hotkey for each operating system; executing a BIOS power on self test program; determining whether any hotkey has been pressed during execution of the power on self test program; activating a disk partition section which stores an operating system corresponding to a hotkey if the hotkey has been pressed; loading a master boot record; starting the operating system stored in the activated disk partition section.

Other advantages and novel features of the present invention will become more apparent from the following detailed description of preferred embodiments when taken in conjunction with the accompanying drawings, in which:

### BRIEF DESCRIPTION OF DRAWINGS

FIG. 1 is a schematic diagram of hardware configuration of a computer in accordance with a preferred embodiment;

FIG. 2 is a flowchart of a method for preestablishing hotkeys for various operating systems by utilizing the computer of FIG. 1; and

FIG. 3 is a flowchart of a method for starting an operating system rapidly by pressing a hotkey by utilizing the computer of FIG. 1.

### DETAILED DESCRIPTION

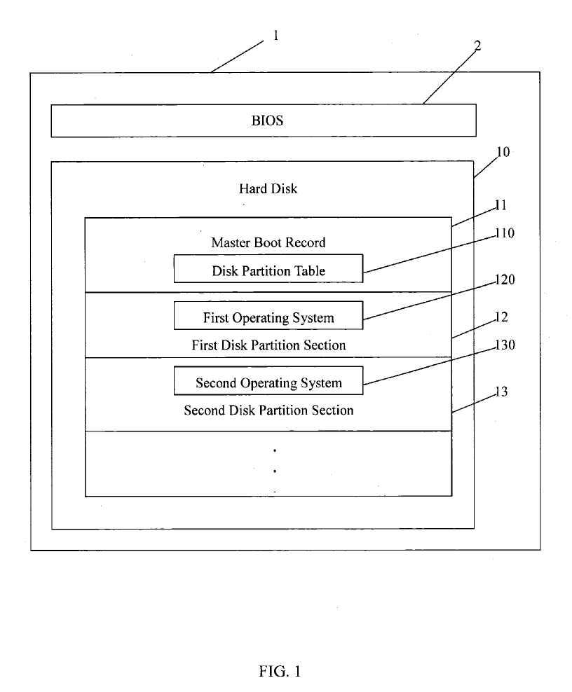

FIG. 1 is a schematic diagram of hardware configuration of a computer in accordance with a preferred embodiment. The computer 1 typically includes a basic input/output system (BIOS) 2 and a hard disk 10, and may include other essential components such as a central processing unit, a memory (not shown), etc. The hard disk 10 is constituted by some platters. Each platter has two read/write heads, with one on the top surface of the platter and one on the bottom surface. Each platter stores data in a specific pattern for accessing of reading and writing. The data is stored into tracks which are rings around the platter. All the corresponding tracks taken together are collectively called a cylinder. A sector (512 Byte) is a section of data in the cylinder. CHS (Cylinders-Heads-Sectors) is a way to address sectors on a hard disk.

The hard disk 10 includes a master boot record (MBR) 11, a first disk partition section 12, a second disk partition section 13, and other disk partition sections (not shown). The MBR 11 is located at 0 cylinder, 0 head, 1 sector of the hard disk 10, and stores a DPT (Disk Partition Table) 110. The DPT 110 is used for recording information of the partition sections in the hard disk 10. After the BIOS 2 executes the POST (power on self test) program, the MBR 11 activates a disk partition section in the hard disk 10 to start an operating system.

The first disk partition section 12 and the second disk partition section 13 are set as boot partition sections for storing operating systems, and respectively includes a first operating system 120 and a second operating system 130. Either the first operating system 120 or the second operating system 130 can be any kind of operating system according to favorites of the user, such as Windows 2000, Windows XP or any other operating system. More disk partition sections can be set as boot partition sections, and more different operating systems can be stored in the disk partition sections. Each disk partition section is addressed by CHS, and can be set as a hide partition section so as to protect the operating system stored in the disk partition section.

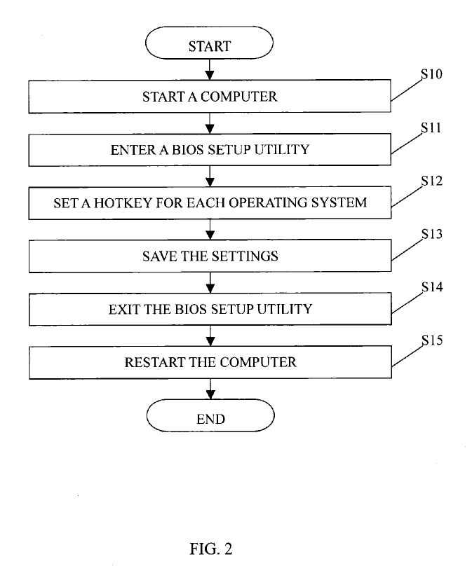

FIG. 2 is a flowchart of a method for preestablishing hotkeys for various operating systems by utilizing the computer 1 of FIG. 1. In step S10, a user starts the computer 1. In step S11, the user enters a BIOS setup utility by pressing a particular key or a key combination on boot-up. The key combination is usually displayed immediately after the user starts the computer 1, such as “Press XXX to enter Setup” at the bottom of the screen. In many BIOS versions, “XXX” is the button “DEL” on a keyboard coupled to the computer 2. In this case, the user needs to press the button “DEL” to enter the BIOS setup utility. Once the user enters into the BIOS setup utility, he/she will see a variety of options, arranged in a two-column format on the screen. At the top of the screen is a title, which tells the user that he/she is in the BIOS setup utility.

In step S12, the user sets a hotkey for each operating system in the BIOS setup utility according to his/her favorites. The user can press one of the hotkeys to start a corresponding operating system when the computer 1 is powered on. If no hotkeys are set in this step, the computer 1 starts with an operating system defaulted by the BIOS 2.

In step S13, the BIOS 2 saves the settings of the hotkeys. In step S14, the user exits the BIOS setup utility. Then, in step S15, the computer 1 is restarted.

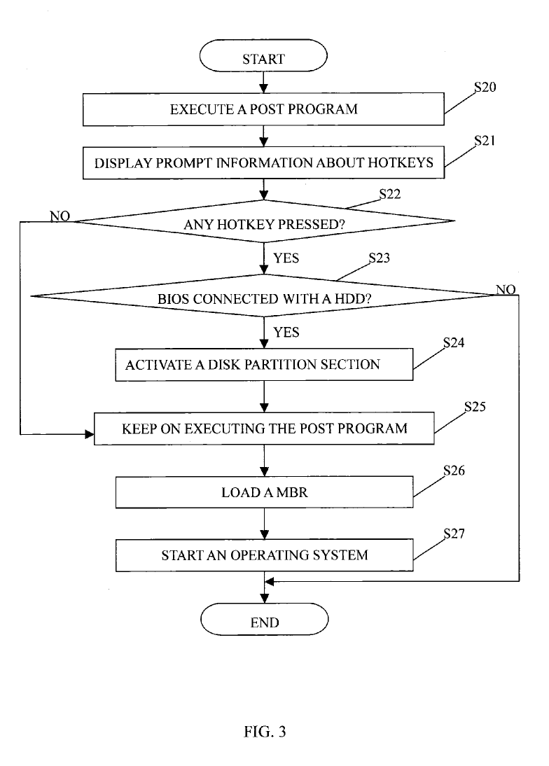

FIG. 3 is a flowchart of a method for starting an operating system rapidly by pressing a hotkey by utilizing the computer 1 of FIG. 1. In step S20, the BIOS 2 executes a POST program. In step S21, the computer 1 displays prompt information about hotkeys preestablished by a user. For example, if “F1” is preestablished by the user as a hotkey to start Windows XP, the computer 1 displays information indicating that “F1” corresponds to Windows XP.

In step S22, the computer 1 determines whether any preestablished hotkey has been pressed during execution of the POST program via an interrupt command of the BIOS 2, such as INT 19. If any preestablished hotkey has been pressed, in step S23, the computer 1 determines whether the BIOS 2 connects to a hard disk drive (HDD). If the BIOS 2 does not connect to any hard disk drive, the procedure ends.

If the BIOS 2 connects to a hard disk drive, in step S24, the BIOS 2 is modified in order to activate a disk partition section which stores an operating system corresponding to the pressed hotkey. In this preferred embodiment, the modification of the BIOS 2 can be accomplished by following source codes:

| | |
|---|---|
| PressHotKey: | |
| mov ax, 0301h | ;write MBR sector |
| mov cx, 0002h | ;backup MBR to second sector |
| mov dx, 0080h | |
| mov bx, 07C00h | |
| int 13h | |
| mov bh, Flag_boot | ;ax=(4-flag_boot)*16 |
| call Mul_16_offset | ;bx=start table byte |
| mov byte ptr[bx], 00h | ;set normal boot=00 |
| mov bh, Flag_12 | ;ax=(4-flag_12)*16 |
| call Mul_16_offset | ;bx=start table byte |
| mov byte ptr[bx], 80h | ;set partition table #4 80 ---bootable |
| mov byte ptr[bx+4], 0Ch | ;set hidden type |
| mov ax, 0301h | ;write MBR sector |
| mov cx, 0001h | |
| mov dx, 0080h | |
| mov bx, 07C00h. | |

In step S25, the BIOS 2 keeps on executing the POST program. In step S26, the BIOS 2 loads the MBR 11 after executing the POST program. In step S27, the MBR 11 searches the activated disk partition section and starts the operating system stored in the disk partition section. If no disk partition section has been activated, the MBR 11 starts with a default operating system.

If no preestablished hotkey has been pressed in step S22, the procedure goes directly to step S25.

The above-described method for starting an operating system rapidly by pressing a hotkey is also applicable for starting a backup operating system corresponding to a destroyed operating system.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A method for starting an operating system rapidly by pressing a hotkey, the method comprising the steps of:
setting a hotkey for each operating system;
executing a BIOS power on self test program;
determining whether any hotkey has been pressed during execution of the power on self test program;
activating a disk partition section which stores an operating system corresponding to a hotkey if the hotkey has been pressed;
loading a master boot record; and
starting the operating system stored in the activated disk partition section.

2. The method according to claim 1, further comprising the step of:
displaying prompt information about the set hotkeys.

3. The method according to claim 1, wherein the step of determining whether any hotkey has been pressed during execution of the POST program comprises:
starting the operating system defaulted by the BIOS.

4. The method according to claim 1, wherein the step of determining whether any hotkey has been pressed during execution of the POST program is executed by an interrupt command of the BIOS.

5. The method according to claim 4, wherein the interrupt command is INT 19.

6. The method according to claim 1, wherein the disk partition section is stored in the master boot record.

7. The method according to claim 1, wherein the operating system is a backup operating system corresponding to a destroyed operating system.
